(19) United States
(12) Patent Application Publication
(10) Pub. No.: US 2005/0127213 A1
(43) Pub. Date: Jun. 16, 2005

(54) Modifications to the urea granulator molten spray boom to improve product quality

(76) Inventor: Kenneth R. Pasay, Sherwood Park (CA)

Correspondence Address: Arne I. Fors;c/o Gowling Lafleur Henderson LLP, Suite 4900, Commerce Court West, Toronto, ON, M5L 1J3, CA

(21) Appl. No.: 10/733,330

(22) Filed: Dec. 12, 2003

(51) Int. Cl. A01C 23/00

(52) U.S. Cl. 239/662

(57) ABSTRACT

A spraying apparatus for use in a granulator drum including a spray boom for extension into the drum, a single conduit means formed in the spray boom coaxial therewith and supported by the spray boom for supplying liquid fertilizer compound selected from the group consisting of molten urea or ammonium nitrate, an annulus defined between the tubular spray boom and the conduit means, insulation substantially filling said annulus, a plurality of equispaced spray means in communication with the single conduit means supported by the spray boom, each spray means including a first vertically-downward pipe section connected radially to the conduit means and a second pipe section attached to the first pipe section having a distal end defining an angle of about 110 to 120° to the first pipe section, and a spray nozzle attached to the distal end of the second pipe section for uniformly spraying liquid fertilizer compound.

### BACKGROUND OF THE INVENTION

(i) Field of the Invention

This invention relates to a spraying apparatus and more particularly to a spraying apparatus for use in the production of granular fertilizers from molten fertilizer compounds.

(ii) Description of the Related Art

It is known to produce granular fertilizers such as granular urea and ammonium nitrate by spraying molten compound from a plurality of spray heads onto solid particles cascading within a rotating drum and solidifying the molten compound by cooling the particles in a current of cool air passing through the drum.

A typical spraying apparatus for use within a rotating granulating drum mounted for rotation about a substantially horizontal axis to spray a molten liquid compound within the drum comprises a conduit cantilevered to extend within the drum, a plurality of pipes within the conduit each having a control valve to conduct the molten liquid compound to the drum interior, a spray head connected to each pipe to spray the liquid compound within the drums; and steam lines having individual control valves for each line within the conduit in heating relation with the pipes to maintain the compound in liquid form prior to spraying from the spray heads onto the cascading particles. Start-up of the system and control of desired steam temperatures for optimum melt characteristics were complicated and difficult to maintain.

A typical process for granulating molten fertilizer comprises the steps of forming a bed of continuously moving, solid nuclei particles of fertilizer compound in a granulating zone of a rotating drum and advancing the particles through the granulating zone while spraying a molten, substantially anhydrous melt of fertilizer such as urea at a temperature of about 5 to 25 C.° above its crystallization temperature onto the bed and into a continuously cascading curtain of solid particles in the granulating zone. The curtain of solid particles is contacted with a current of cooling air flowing countercurrent to the direction of the advance of the particle from the granulating zone to a cooling zone of the rotating drum while continuously passing cooling air from the cooling zone to the granulating zone. Cooled solid particles withdrawn from the cooling zone are separated according to size, particles of a desired size range are collected from the withdrawn particles, and undersize and crushed oversize particles are recycled to the granulating zone.

In operation, solid nuclei particles are introduced into the granulating zone of the drum and the rotation of the drum equipped with lifters produces the cascade or curtain of the particles within the drum, while the lowermost part of the drum contains a bed of the particles. If the spray density is too great, the nuclei particles become wetted and agglomerate, while if the density is too low the spray solidifies before coating the particles and undesired quantities of fines are produced that recirculate through the system as dust, thus reducing the efficiency of the process. Control of the process to provide optimum production of desired spherical granules in an efficient fashion with a reduced product temperature, an increase of loose bulk density, and reduction on non-spherical product is obtained by closely controlling the position of the spray heads in relation to the established cascading curtain of solid nucleating particles in the granulating zone.

In order to satisfactorily spray a liquid fertilizer compound such as molten urea or ammonium nitrate over solid particles within the granulating zone of a rotating drum, it is necessary to maintain the temperature of the molten spray within very close limits, avoid local hot or cold spots in the deposition zone, and closely control the rate and distribution of the molten spray.

It is therefore a principal object of the present invention to provide a spray apparatus for the production of granular fertilizers which is simple in construction and which utilizes a minimum of component parts without the need for steam heating of molten fertilizer compound.

Another object of the invention is the provision of a method which is simple in operation and which provides close control of the spraying process for the consistent production of spherical fertilizer granules with increased loose bulk density and a reduced product temperature.

### SUMMARY OF THE INVENTION

The invention thus provides a method of spraying a liquid nitrogenous compound onto a bed and a continuously cascading curtain of solid particles within the granulating zone of a rotating drum whereby the liquid compound is introduced within the granulating zone to be sprayed over the particles from a plurality of spray heads suspended within said drum and wherein the height, distance and uniformity and distribution of molten spray relative to the cascading curtain of the bed may be optimized.

In its broad aspect, the spraying apparatus of the invention for use in a granulator drum having a granulating zone containing a bed of cascading fertilizer particles comprises a tubular spray boom extending into the drum through the drum granulating zone in proximity to the bed of cascading fertilizer particles, a single conduit means formed in the spray boom coaxial therewith and supported by the spray boom for supplying liquid fertilizer compound such as molten urea or ammonium nitrate, an annulus defined between the tubular spray boom and the conduit means, insulation substantially filling said annulus, a plurality of equispaced spray means in communication with the single conduit means supported by the spray boom in the drum granulating zone, each spray means including a first vertically-downward pipe section connected radially to the conduit means and a second pipe section attached to the first pipe section having a distal end defining an angle of about 110 to 120° to the first pipe section, i.e. about 60 to 70° to the vertical, and a spray nozzle attached to the distal end of the second pipe section for uniformly spraying liquid fertilizer compound onto the bed of cascading fertilizer particles.

In a preferred embodiment, the angle of the second pipe section to the first pipe section is about 115°, the first pipe section is about 10 inches long, the spray nozzle is about 20 inches from the end of the first pipe section, and the spray nozzle defines a square spray pattern.

### BRIEF DESCRIPTION OF THE DRAWINGS

The method and apparatus of the present invention will now be described with reference to the accompanying drawings, in which:

FIG. 1 is a perspective view, partly cut away, of an embodiment of a spray boom apparatus of the present invention for installation in a rotating granulating drum;

FIG. 2 is a schematic sectional view of the spray boom apparatus along the line 2-2 of FIG. 1;

FIG. 3 is a longitudinal section of the spray boom apparatus shown in FIGS. 1 and 2;

FIG. 4 is a side elevation, partially cut away, of a melt conduit incorporated into the spray boom;

FIG. 5 is a sectional view taken along line 5-5 of FIG. 4 showing a spray nozzle assembly of the invention;

FIG. 6 is a perspective view of a spray nozzle assembly of the invention showing a square spray nozzle;

FIG. 7 is an end view of the square spray nozzle shown in FIG. 6;

FIG. 8 is a section, partly in elevation, taken along line 8-8 of FIG. 7; and

FIG. 9 is a longitudinal section of the drum shown in FIG. 1 illustrating the spray boom in operation.

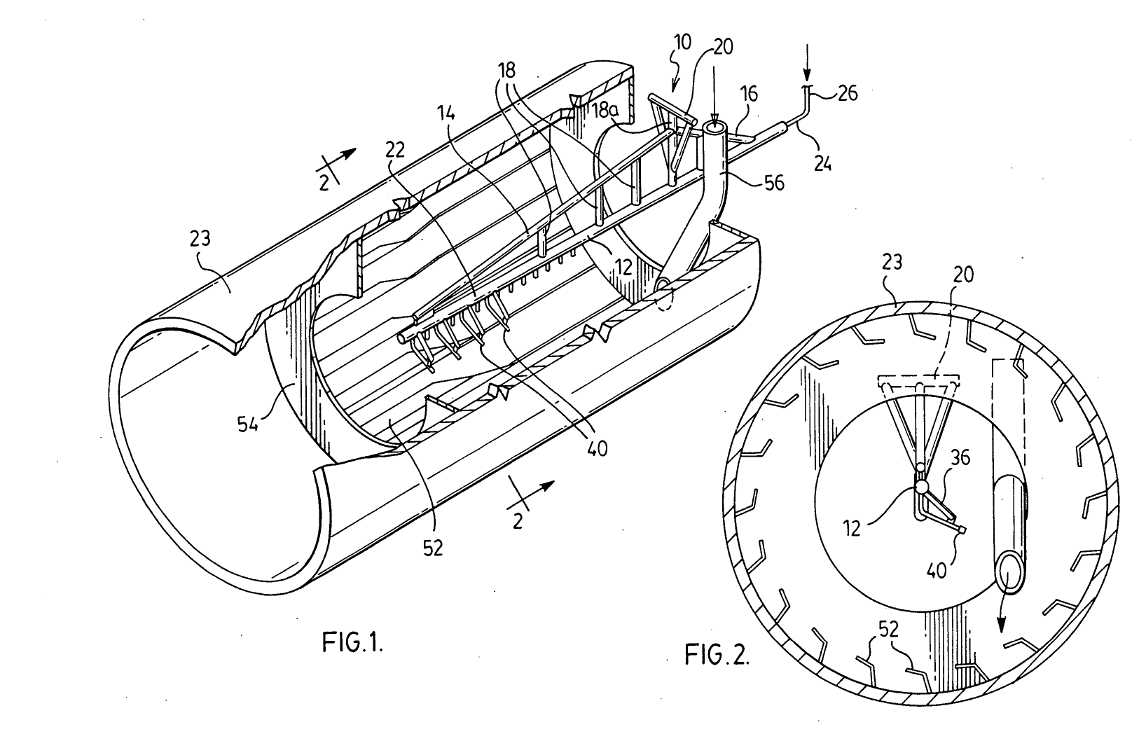

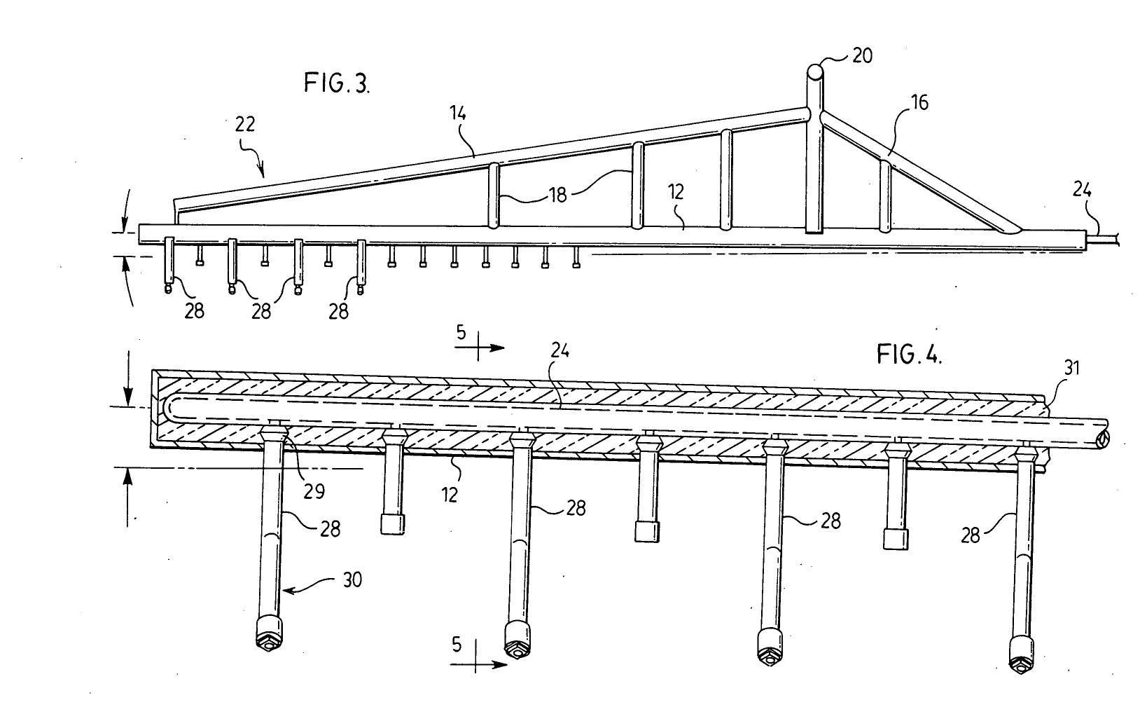

With reference to FIGS. 1-3 of the drawings, spray boom 10 comprises a rigid triangular steel truss structure having lower horizontal tubular beam 12 and upper tubular beams 14, 16 interconnected by cross-members 18. Transverse bar 20 welded to cross-member 18a functions as a pivot support for inserting boom end 22 into a rotary drum 23 and for raising and lowering boom end 22 within the rotary drum.

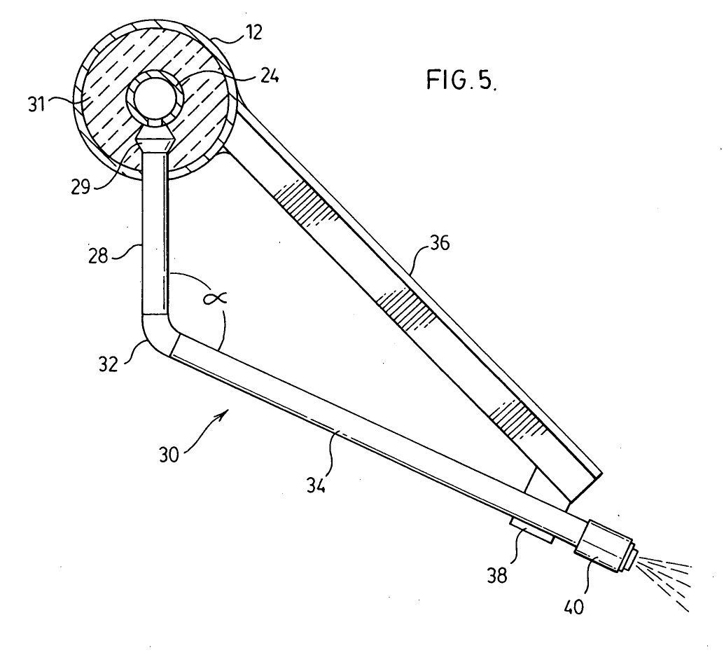

Turning to FIGS. 4 and 5, the melt feed conduit consists of a steel pipe 24 axially aligned within tubular beam 12 and extending the length thereof with a feed inlet 26 at the proximal end and a plurality of equispaced discharge pipes 28 extending through holes in tubular beam 12 and threaded into sockets 29 welded into pipe 24. The annulus defined between tubular beam 12 and central pipe 24 is filled with insulation 31.

Each spray assembly 30 consists of a first vertical pipe section 28 extending downwardly from beam 12, an elbow 32 threaded onto pipe section 28 and a second pipe section 34 threaded into elbow 32 defining an angle ∞ of about 110 to 120° to pipe 28 in a vertical plane perpendicular to the length of beam 12 (FIG. 5). A hanger gusset 36 welded to beam 12 has a bracket 38 formed at its end for engaging and supporting the distal end of second pipe section 34. A spray nozzle 40 threaded onto the distal end of second pipe section 34 preferably discharges the molten fertilizer compound in a square spray pattern.

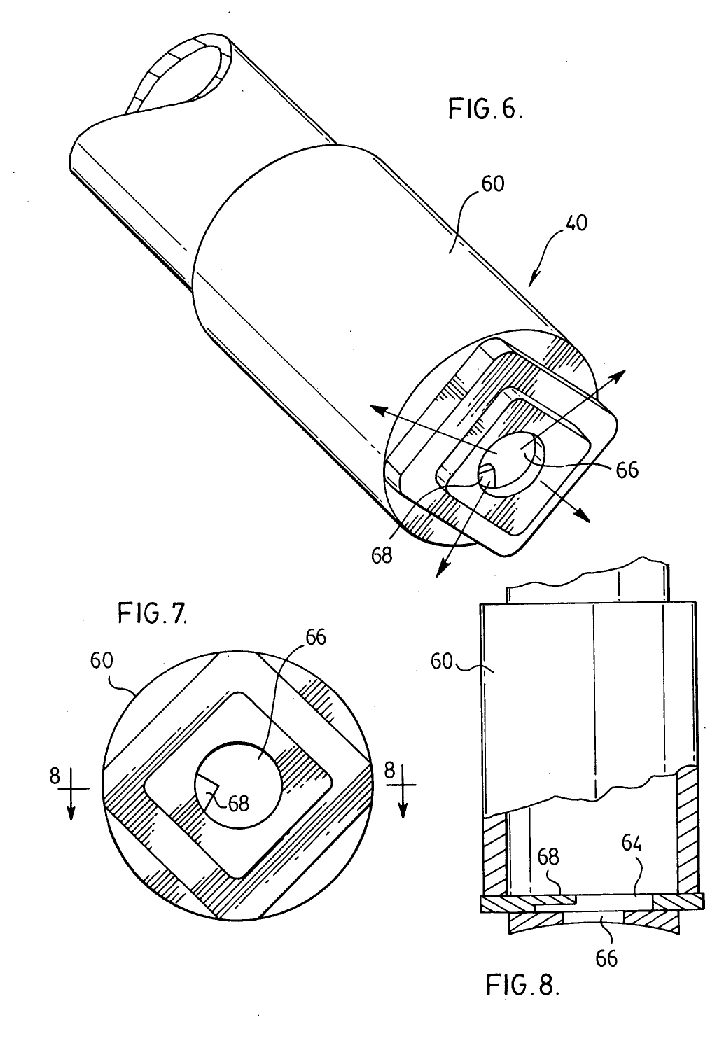

Spray nozzle 40, shown in FIGS. 6, 7 and 8, comprises housing 60 having a square inner opening 64 concentric with circular outer opening 66. V-shaped deflector 70 extending into circular opening 66 deflects liquid melt discharging from the interior of nozzle 40 into a substantially square pattern.

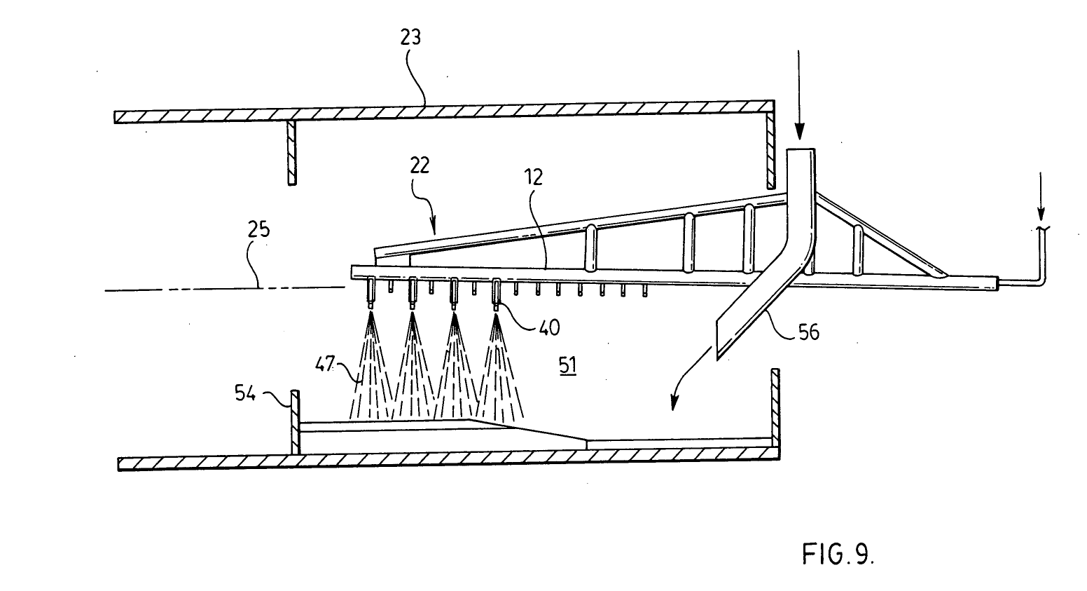

With reference now to FIGS. 1, 2, 5 and 9, spray boom distal end 22 is shown within rotary drum 23 with beam 12 substantially axially aligned with the centre axis 25 of drum 23 but with a downward slope. Equispaced spray header assemblies 30 comprise a 10-inch pipe section 28 depending downwardly from beam 12 with the spray nozzles 40 located about 20 inches from the end of pipe section 28 at elbow 32 and directed preferably at an angle of about 65° to the vertical, perpendicular to the longitudinal axis of beam 12.

In operation, molten fertilizer at a temperature in the temperature range of about 5 to 25 C.° above its crystallization temperature is introduced at feed inlet 26 to insulated pipe 24 and flows to the interior of drum 23 and downwardly through equispaced pipes 28 to inclined pipes 34 for discharge out of spray nozzles 40 as a fine spray onto a bed of cascading fertilizer particles in granulating zone 51 defined at its discharge end by retaining ring 54. Granulating particles are introduced to granulating zone 51 by make-up pipe 56. Nozzles 40 preferably are about four feet from lifters 52 of drum 23.

The invention provides a number of important advantages. Costly steam jacketing of fertilizer melt feed lines is obviated, substantially improving ease of operation and minimizing costs. The quality of the fertilizer product is improved with production of larger and more uniform fertilizer granules.

It will be understood, of course, that modifications can be made in the embodiments of the invention illustrated and described herein without departing from the scope and purview of the invention as defined by the appended claims.

1. A spraying apparatus for use in a granulator drum having a granulating zone containing a bed of cascading fertilizer particles comprising, a spray boom extending into the drum through the drum granulating zone in proximity to the bed of cascading fertilizer particles, a single conduit means formed in the spray boom coaxial therewith and supported by the spray boom for supplying liquid fertilizer compound selected from the group consisting of molten urea or ammonium nitrate, an annulus defined between the tubular spray boom and the conduit means, insulation substantially filling said annulus, a plurality of equispaced spray means in communication with the single conduit means supported by the spray boom in the drum granulating zone, each spray means including a first vertically-downward pipe section connected radially to the conduit means and a second pipe section attached to the first pipe section having a distal end defining an angle of about 110 to 120° to the first pipe section, and a spray nozzle attached to the distal end of the second pipe section for uniformly spraying liquid fertilizer compound onto the bed of cascading fertilizer particles.

2. A spray apparatus as claimed in claim 1 in which the liquid fertilizer compound is molten urea.

3. A spray apparatus claimed in claim 2 in which the angle of the second pipe section to the first pipe section is about 115°, the first pipe section is about 10 inches long, and the spray nozzle is about 20 inches from the first pipe section.

4. A spray apparatus as claimed in claim 3 in which the spray nozzle defines a square spray pattern.
